(19) United States
(12) Patent Application Publication
(10) Pub. No.: US 2013/0335330 A1
(43) Pub. Date: Dec. 19, 2013

(54) MEDIA PROCESSING INPUT DEVICE

(71) Applicant: MICROSOFT CORPORATION, Redmond, WA (US)

(72) Inventors: David M. Lane, Sammamish, WA (US); Young Soo Kim, Bellevue, WA (US); Timothy C. Shaw, Sammamish, WA (US)

(73) Assignee: MICROSOFT CORPORATION, Redmond, WA (US)

(21) Appl. No.: 13/655,065

(22) Filed: Oct. 18, 2012

Related U.S. Application Data
(60) Provisional application No. 61/659,364, filed on Jun. 13, 2012.

(51) Int. Cl. G06F 3/02

(52) U.S. Cl. 345/168

(57) ABSTRACT

Media processing input devices are described. In one or more implementations, an input device includes a connection portion having at least one communication contact configured to form a communicative coupling with a computing device and a magnetic coupling device to form a removable magnetic attachment to the computing device to secure the connection portion to the computing device. The input device also includes an input portion comprising a plurality of keys that are configured to generate signals to be processed by a computing device as inputs, the signals to specify processing of media to be performed by the computing device. The input device further includes a flexible hinge that is configured to flexibly connect the connection portion to the input portion, the flexible hinge having one or more conductors configured to communicatively couple the plurality of keys with the communication contact

### RELATED APPLICATIONS

This application claims priority under 35 U.S.C. 119(e) to U.S. Provisional Patent Application No. 61/659,364, filed Jun. 13, 2012, and titled “Music Blade,” the entire disclosure of which is incorporated by reference.

### BACKGROUND

Conventional media processing equipment is typically dedicated solely to the purpose of processing media. Therefore, this equipment could be expensive, unwieldy, and involve proprietary connections and features that were particular to the equipment.

Consequently, conventional media processing equipment was often limited to use by professional users as casual users often chose to forgo this equipment due to a variety of considerations. These considerations may include a lack of portability of the equipment and cost of the equipment.

### SUMMARY

Media processing input devices are described. In one or more implementations, an input device includes a connection portion having at least one communication contact configured to form a communicative coupling with a computing device and a magnetic coupling device to form a removable magnetic attachment to the computing device to secure the connection portion to the computing device. The input device also includes an input portion comprising a plurality of keys that are configured to generate signals to be processed by a computing device as inputs, the signals to specify processing of media to be performed by the computing device. The input device further includes a flexible hinge that is configured to flexibly connect the connection portion to the input portion, the flexible hinge having one or more conductors configured to communicatively couple the plurality of keys with the communication contact.

In one or more implementations, an input device includes an input portion configured to generate signals to be processed by a computing device as inputs for processing of media, the input portion including a radial dial pad. The input device also includes a connection portion having at least one communication contact configured to form a communicative coupling with the computing device to communicate the generated signals and a magnetic coupling device to form a removable magnetic attachment to the computing device. The input device further includes a flexible hinge that is configured to flexibly connect the connection portion to the input portion.

In one or more implementations, a system includes a computing device having a housing that assumes a handheld form factor and an input device comprising a connection portion configured to be removably physically secured to the computing device using magnetism which, when so secured, supports a communicative coupling between a plurality of keys of the input device and the computing device, one or more said keys configured to provide inputs to an application that is executable on the computing device to process music using beat synchronization.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ the techniques described herein.

FIG. 2 depicts an example implementation of an input device of FIG. 1 as showing a flexible hinge in greater detail.

FIG. 3 depicts an example orientation of the input device in relation to the computing device as covering a display device of the computing device.

FIG. 4 depicts an example orientation of the input device in relation to the computing device as assuming a typing orientation.

FIG. 5 depicts an example orientation of the input device in relation to the computing device as covering a rear housing of the computing device and exposing a display device of the computing device.

FIG. 6 depicts an example orientation of the input device as including a portion configured to cover a rear of the computing device, which in this instance is used to support a kickstand of the computing device.

FIG. 7 depicts an example orientation in which the input device including the portion of FIG. 6 are used to cover both the front and back of the computing device.

FIG. 8 depicts an example implementation showing a perspective view of a connection portion of FIG. 2 that includes mechanical coupling protrusions and a plurality of communication contacts.

FIG. 9 depicts a cross section taken along an axis showing a communication contact as well as a cross section of a cavity of the computing device in greater detail.

FIG. 10 depicts a cross section of the computing device, connection portion, and flexible hinge of the input device as being oriented as shown in FIG. 3 in which the input device acts as a cover for a display device of the computing device.

FIG. 11 depicts a cross section taken along an axis showing a magnetic coupling device as well as a cross section of the cavity of the computing device in greater detail.

FIG. 12 depicts an example of a magnetic coupling portion that may be employed by the input device or computing device to implement a flux fountain.

FIG. 13 depicts another example of a magnetic coupling portion that may be employed by the input device or computing device to implement a flux fountain.

FIG. 14 depicts a cross section taken along an axis showing a mechanical coupling protrusion as well as a cross section of the cavity of the computing device in greater detail.

FIG. 15 illustrates an example system including various components of an example device that can be implemented as any type of computing device as described with reference to FIGS. 1-15 to implement embodiments of the techniques described herein.

### DETAILED DESCRIPTION

Overview

Convention media processing equipment used by DJs and other users to process music, videos, and so on is often unwieldy and dedicated solely for that purpose. Accordingly, this equipment could be expensive and the use of which was thus often limited to professional users and avoided by casual users as the expense of obtaining and learning how to use this equipment could be prohibitive. Further, even professional users may be confronted with the lack of mobility of conventional media processing equipment.

A media processing input device is described. In one or more implementations, a media processing input device is configured to be removably attached to a computing device, such as a tablet computer. The media processing input device is configured to provide access to media processing features that may be employed by a DJ and other users to process media. This may include features to compose and output media, such as to perform beat synchronization, track selection and mapping, production and editing, sequencing, and so on. In this way, the input device may leverage functionality of a multi-purpose computing device to provide features conventionally limited to dedicated equipment without reduced cost in comparison with the dedicated equipment. Further, these features may be provided by a portable device having a hand held form factor. Thus, this media processing input device may be used by casual users as well as professional users desiring increased portability over conventional equipment. Further discussion of these and other implementations such as use of a radial dial pad, removable connectivity, and so on may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

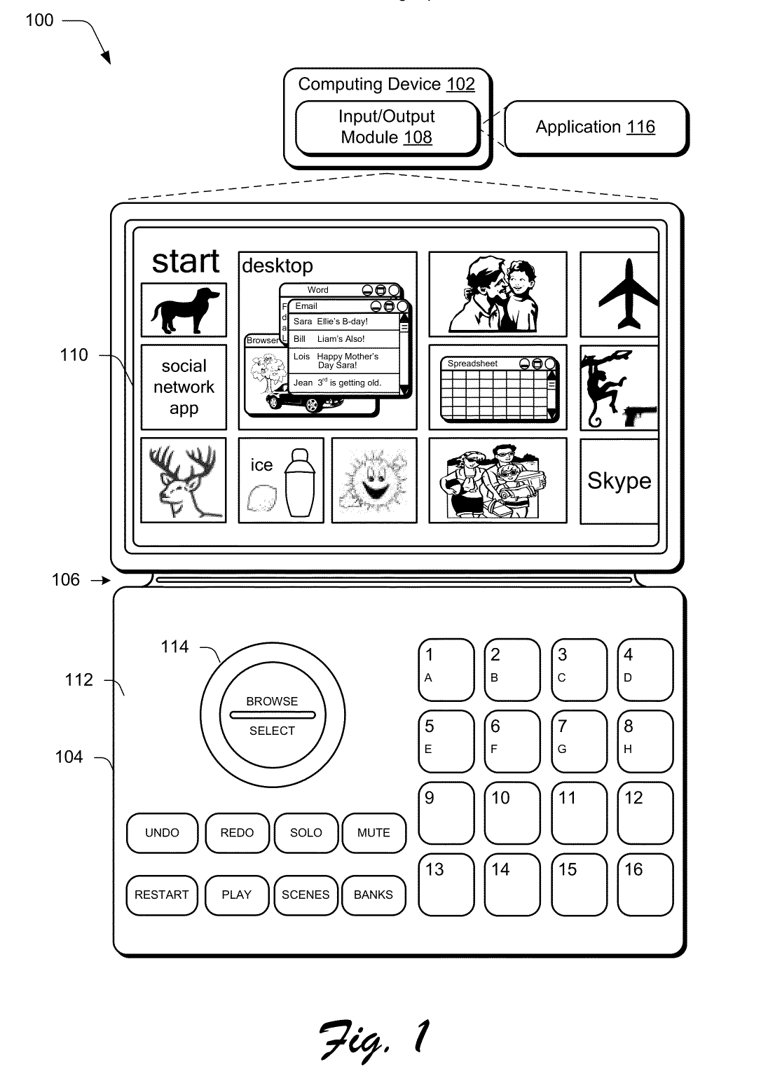

FIG. 1 is an illustration of an environment 100 in an example implementation that is operable to employ the techniques described herein. The illustrated environment 100 includes an example of a computing device 102 that is physically and communicatively coupled to an input device 104 via a flexible hinge 106, although other implementations are also contemplated.

The computing device 102 may be configured in a variety of ways. For example, the computing device 102 may be configured for mobile use (e.g., handheld), such as a mobile phone, a tablet computer as illustrated, and so on. Thus, the computing device 102 may range from full resource devices with substantial memory and processor resources to a low-resource device with limited memory and/or processing resources.

The computing device 102 is illustrated as including an input/output module 108. The input/output module 108 is representative of functionality relating to processing of inputs and rendering outputs of the computing device 102. A variety of different inputs may be processed by the input/output module 108, such as inputs relating to functions that correspond to keys of the input device 104, keys of a virtual keyboard displayed by the display device 110 to identify gestures and cause operations to be performed that correspond to the gestures that may be recognized through the input device 104 and/or touchscreen functionality of the display device 110, and so forth. Thus, the input/output module 108 may support a variety of different input techniques by recognizing and leveraging a division between types of inputs including key presses, gestures, and so on.

In the illustrated example, the input device 104 is configured as having an input portion that is configured to provide inputs relating to processing of media for output, although other arrangements of keys are also contemplated. Thus, the input device 104 and keys incorporated by the input device 104 may assume a variety of different configurations to support a variety of different functionality.

The input device 104 is illustrated as including an input portion 112 having a plurality of keys. The plurality of keys are configured to provide inputs to the computing device 102 (e.g., an application executed by the computing device 102) that are related to processing of media. In the illustrated example, a design consistent with processing of music is shown although it should be readily apparent that other designs are also contemplated, such as for video processing or other media.

A portion of the keys in the illustrated example form a grid (e.g., four by four) configured to operate as sound pads that may be employed to provide inputs for processing. The sound pads may be configured to include multi-color backlighting, low-light backlighting, and so on. This lighting of the sound pads and other keys may be leveraged for a variety of different uses. For example, a teaching mode may be supported in which the backlighting is performed to indicate respective functions that are performable by the keys to process media. A variety of other examples that leverage the backlighting are also contemplated.

One or more of the plurality of keys may be configured to be pressure sensitive. For example, an output from a respective one of the keys may indicate an amount of pressure applied to the key through the use of a force sensitive ink and flexible membrane. This amount of pressure as indicated by the keys may be leveraged for a variety of purposes, such as to adjust a velocity of a sound, volume of a sound, indicate different inputs, and so forth.

The sound pads may also support a variety of modes. For example, the pads may be mapped to particular tracks of media and thus use of the pad may initiate the mapped track of media. This may be performed through interacting with a user interface displayed on the display device 110 through execution of the application 114 or other software.

The sound pads may also operate in bank and shift modes. The shift modes may include copy, paste, and quantization options. The illustrated grid includes indications of pad numbers to correspond to respective functionality output on the display device 110, e.g., by the application 114.

The use of different modes may be indicated by employing a backlight, such as use of a blue backlight to indicate a main play mode and an orange backlight to indicate a shift mode. In another example, a record operation may be indicated by a red backlight of a particular key while a play/pause operation may be indicated by a blue backlight for the same key or different keys. In one or more implementations, a sensor may be used to detect an amount of ambient light and adjust a level of light output by the backlight in accordance with this detection. Additionally, effects may be employed to fade from output of one backlight to another.

The illustrated configuration shows a close proximity between the display device 110 of the computing device 102 and keys of the input device 104. As previously stated, the display device 110 may also support touch functionality. Therefore, a user may interact with a user interface output by the display device 110 and keys of the input device 104 in an efficient manner due to this close proximity. In this way, a user is provided with a variety of different techniques to specify how processing of the media is to be performed.

The input portion 112 of the input device 104 is also illustrated as including keys to provide inputs that relate to control functions of the computing device. Examples of this include a row of keys that include undo, redo, clear (e.g., delete all), and restart. Another row of keys is also illustrated as including keys to play/pause, record, erase, and shift. Keys may also be included to select particular banks, e.g., A, B, C, D, and so forth through pressing of a shift and a respective one of the keys of the sound pad. Accordingly, keys may be used to initiate a plurality of different processing operations.

The input portion 112 is further illustrated as including a radial dial pad 114. The radial dial pad 114 may also be configured to provide a pressure sensitive output, such as through implementation as a plurality of pressure sensitive keys. For example, the radial dial pad 114 may be configured as a plurality of pressure sensitive keys arranged in a radial configuration such that movement as well as location at different points along the radial dial pad 114 may be detected along with an amount of pressure of the inputs as previously described.

The radial dial pad 114 may be configured to provide a variety of different inputs. For example, the radial dial pad 114 may be associated with a portion that is selectable to initiate a browse mode, an example of which is illustrated through use of a browse key within a perimeter of the radial dial pad 114. In this mode, movement around the radial dial pad 114 may be used to navigate between items of media when in the browse mode, e.g., tracks of music, segments of video, and so on.

The radial dial pad 114 may also be associated with a portion to select a particular item of media. This may be accomplished through selection of an item to which a user interface of the computing device 102 has navigated to using the radial dial pad 114. An example of this is shown as a select key that is also disposed within a perimeter of the radial dial pad 114 in the illustrated example.

The radial dial pad 114 may also be used to adjust characteristics of media to be processed by the computing device 102. This may include specifying a change in volume, pitch, swing, specifying an amount of adjustment to be applied by an effect to media, balance, adjusting beats per minute, and so on. A variety of different effects may also be supported, such as delay, reverb, chorus, distortion, equalization, limiting effects, phazer, saturation, and so on. In one or more implementations software of the computing device 102 (e.g., the application 116) may support installation of third-part effects packages and thus functionality of the combination of the input device 104 and the application 116 may be expanded.

Further, the radial dial pad 114 may support a variety of different inputs. This may include detecting an amount of pressure as described above, support sliding movement, support use of tapping on different parts of the radial dial pad 114 to specify amounts of navigation or adjustment, and so forth.

The input device 104 may be configured to operate in conjunction with software of the computing device 104, an example of which is illustrated as application 116. For example, attachment of the input device 104 that is configured to provide inputs related to media processing may cause one or more corresponding applications 116 to be launched automatically and without user intervention. Once the input device 104 is removed, execution of the application 116 may automatically cease, although other examples are also contemplated.

A user interface output through execution of the application 116 may be configured in a variety of ways. The user interface, for instance, may be designed as an immersive application that is optimized for touch, although other interactions are also supported such as through use of a cursor control device. The user interface may include a browsing mode as previously described to allow a user to choose a library mode. The library mode may allow a user to select functions for a group of the sounds pads, such as a bank, type, subtype, filtering that is to be performed to the group as a whole, and so forth.

The library mode may also support a sound mode to specify sounds to be employed to individual keys of the sounds pad, such as a loop, kit, one shot drum, instrument, plug-in, effect, results of filtering, and so on. Other modes may also be supported in the library mode, such as use of patterns, formation and management of sample banks, effect settings, and so forth. Other non-library modes are also contemplated, such as a disc mode that acts as a point to a specific file location that is to be filtered.

The user interface may also support a control area and a timeline editor. The control area may be used to modify each item of media (e.g., sound) in a sequence or group. The timeline editor may be used to describe details of each item of media in proximity to each other and employ a sequencer to capture each scene. The timeline editor may also include a timeline scrubber which describes a current position in an output and/or processing of the media and may be selectable to navigate to different portions of the media.

A menu bar and application bar menu may also be included in the user interface. The menu bar may include a volume control, which may display the amplitude of an output of audio and a fader that controls an output level of an item of media. The application bar menu may be used for mode selection, file selector, initiate a new projection, open an existing project, save a project (e.g., as a MIDI file for export), support a “save as” operation, and so forth.

The user interface may also include a feature area relating to banks of items of media. The application 116, for instance, may support a plurality of banks of media (e.g., four banks of music) that may be loaded as defaults. Banks may be edited and saved by a user through interaction with this feature. This may include an ability to duplicate a bank then save the bank as a new custom bank as well as an ability to create a bank “from scratch.” Each bank may also have its own loop and own number of measures (e.g., segments of media), although other implementations are also contemplated.

As previously described, the input device 104 may be moved in relation to the computing device. Accordingly, in one or more implementations an orientation of the input device 104 to the computing device 102 may be utilized to support different states in execution of the application 116 as well as the input device 104.

For example, as previously described, the input device 104 is physically and communicatively coupled to the computing device 102 in this example through use of a flexible hinge 106. The flexible hinge 106 is flexible in that rotational movement supported by the hinge is achieved through flexing (e.g., bending) of the material forming the hinge as opposed to mechanical rotation as supported by a pin, although that embodiment is also contemplated. Further, this flexible rotation may be configured to support movement in one or more directions (e.g., vertically in the figure) yet restrict movement in other directions, such as lateral movement of the input device 104 in relation to the computing device 102. This may be used to support consistent alignment of the input device 104 in relation to the computing device 102, such as to align sensors used to change power states, application states, and so on.

This rotational movement may result in different orientations of the input device 104 in relation to the computing device 104. These different orientations may be detected using sensors of the computing device 104 and/or input device 104, such as accelerometers, magnetometers, inertial measurement units, gyroscopes, Hall Effect sensors, and so on. The detected orientations may then be used to change a state of the computing device 102 (e.g., application 116 executed by the device) and/or the input device 104.

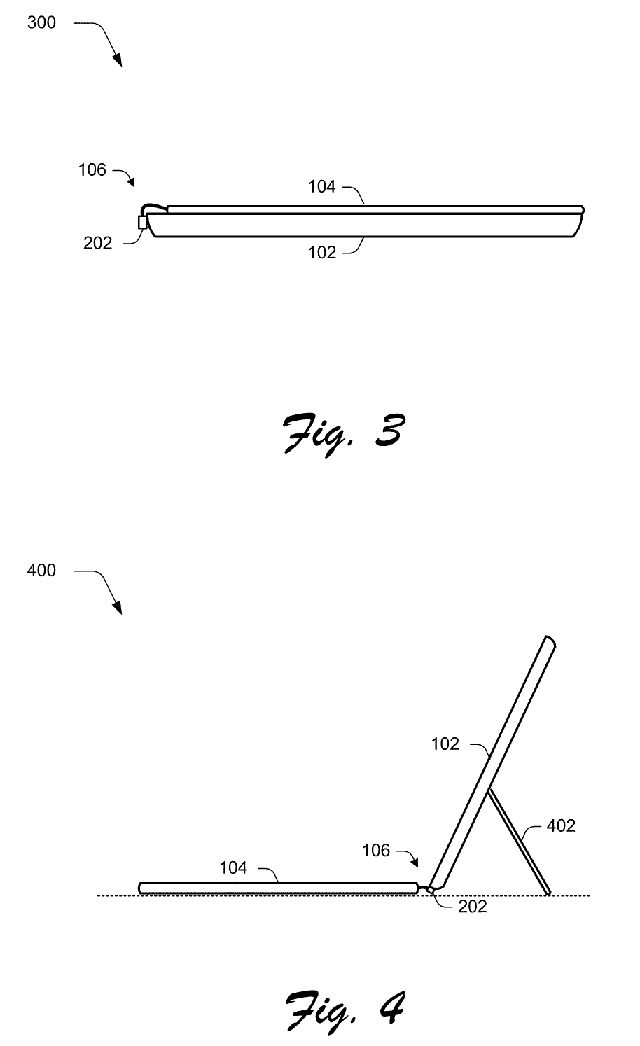

Opening of the input device 104 from a closed orientation as shown in FIG. 3 to an open orientation as shown in FIG. 4, for instance, may cause the application 116 to resume a previous state at which point at which the input device 104 and the computing device 102 were “closed.” Closing of the input device 104 may further cause a history to be deleted or saved. In another example, resuming of the open configuration may cause the application 116 and input device 104 to enter a play mode for output of media. The flexible hinge 106 may be configured to support this movement in a variety of ways, further discussion of which follows.

The flexible hinge 106, for instance, may be formed using one or more layers of fabric and include conductors formed as flexible traces to communicatively couple the input device 104 to the computing device 102 and vice versa. This communication, for instance, may be used to communicate a result of a key press to the computing device 102, receive power from the computing device, perform authentication, provide supplemental power to the computing device 102, and so on. The flexible hinge 106 may be configured in a variety of ways, further discussion of which may be found in relation to the following figure.

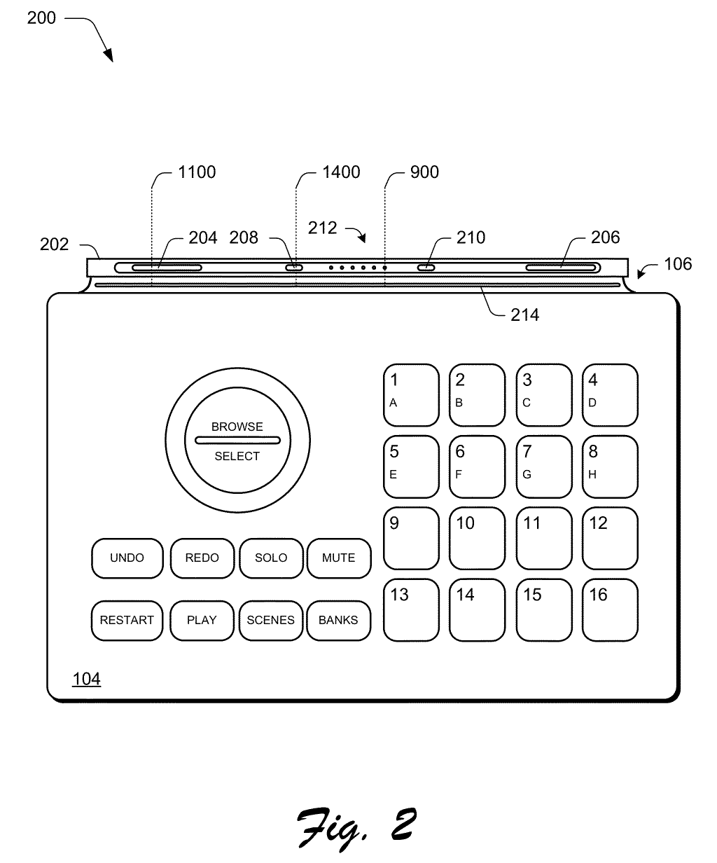

FIG. 2 depicts an example implementation 200 of the input device 104 of FIG. 1 as showing the flexible hinge 106 in greater detail. In this example, a connection portion 202 of the input device is shown that is configured to provide a communicative and physical connection between the input device 104 and the computing device 102. The connection portion 202 as illustrated has a height and cross section configured to be received in a channel in the housing of the computing device 102, although this arrangement may also be reversed without departing from the spirit and scope thereof.

The connection portion 202 is flexibly connected to a portion of the input device 104 that includes the keys through use of the flexible hinge 106. Thus, when the connection portion 202 is physically connected to the computing device the combination of the connection portion 202 and the flexible hinge 106 supports movement of the input device 104 in relation to the computing device 102 that is similar to a hinge of a book.

Through this rotational movement, a variety of different orientations of the input device 104 in relation to the computing device 102 may be supported. For example, rotational movement may be supported by the flexible hinge 106 such that the input device 104 may be placed against the display device 110 of the computing device 102 and thereby act as a cover as shown in the example orientation 300 of FIG. 3. Thus, the input device 104 may act to protect the display device 110 of the computing device 102 from harm.

As shown in the example orientation 400 of FIG. 4, a typing arrangement may be supported. In this orientation, the input device 104 is laid flat against a surface and the computing device 102 is disposed at an angle to permit viewing of the display device 110, e.g., such as through use of a kickstand 402 disposed on a rear surface of the computing device 102.

In the example orientation 500 of FIG. 5, the input device 104 may also be rotated so as to be disposed against a back of the computing device 102, e.g., against a rear housing of the computing device 102 that is disposed opposite the display device 110 on the computing device 102. In this example, through orientation of the connection portion 202 to the computing device 102, the flexible hinge 106 is caused to “wrap around” the connection portion 202 to position the input device 104 at the rear of the computing device 102. Thus, in this orientation the user may access touchscreen functionality of the display device 110 from a front of the device and keys of the input device 104 from a rear of the device.

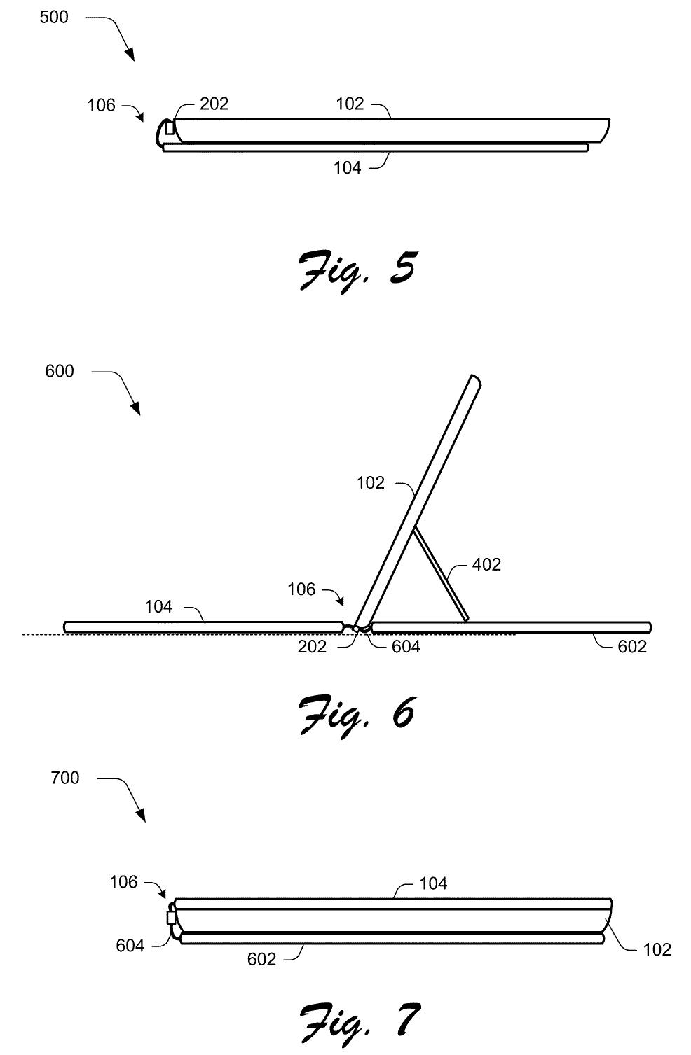

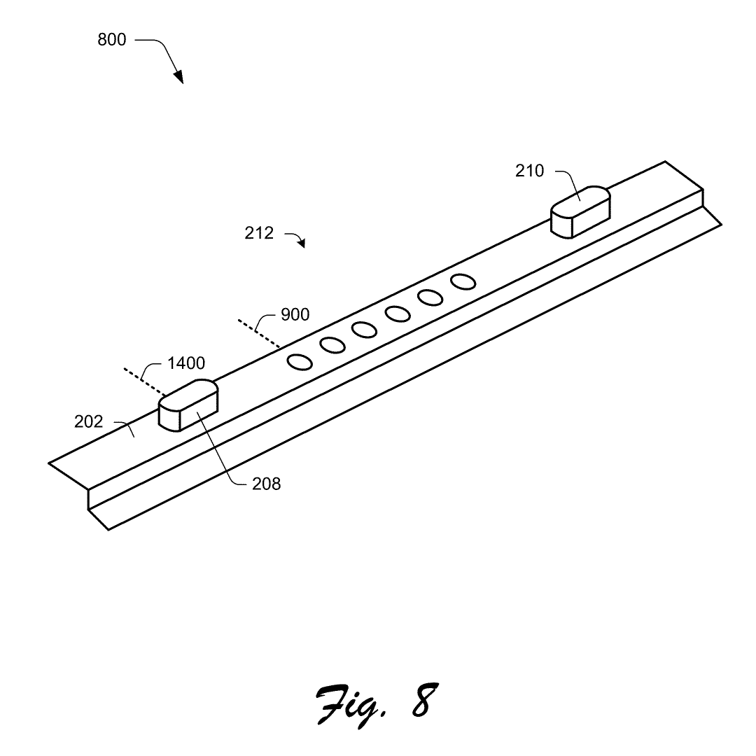

In the example orientation 600 of FIG. 6, the input device 104 is illustrated as including a portion 602 configured to cover a rear of the computing device. This portion 602 is also connected to the connection portion 202 using a flexible hinge 604.

The example orientation 600 of FIG. 6 also illustrates a typing arrangement for interacting with keys of the input device 104 in which the input device 104 is laid flat against a surface and the computing device 102 is disposed at an angle to permit viewing of the display device 110. This is supported through use of a kickstand 402 disposed on a rear surface of the computing device 102 to contact the portion 602 in this example.

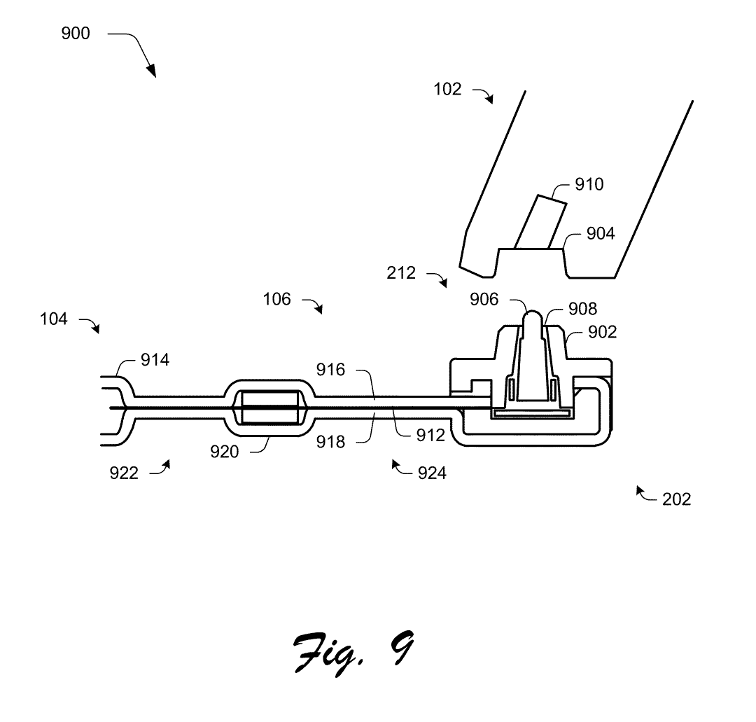

FIG. 7 depicts an example orientation 700 in which the input device 104 including the portion 602 are used to cover both the front (e.g., display device 110) and back (e.g., opposing side of the housing from the display device) of the computing device 102. In one or more implementations, electrical and other connectors may also be disposed along the sides of the computing device 102 and/or the input device 104, e.g., to provide auxiliary power when closed.

Naturally, a variety of other orientations are also supported. For instance, the computing device 102 and input device 104 may assume an arrangement such that both are laid flat against a surface as shown in FIG. 1. Other instances are also contemplated, such as a tripod arrangement, meeting arrangement, presentation arrangement, and so forth.

Returning again to FIG. 2, the connection portion 202 is illustrated in this example as including magnetic coupling devices 204, 206, mechanical coupling protrusions 208, 210, and a plurality of communication contacts 212. The magnetic coupling devices 204, 206 are configured to magnetically couple to complementary magnetic coupling devices of the computing device 102 through use of one or more magnets. In this way, the input device 104 may be physically secured to the computing device 102 through use of magnetic attraction.

The connection portion 202 also includes mechanical coupling protrusions 208, 210 to form a mechanical physical connection between the input device 104 and the computing device 102. The mechanical coupling protrusions 208, 210 are shown in greater detail in relation to FIG. 8, which is discussed below.

FIG. 8 depicts an example implementation 800 showing a perspective view of the connection portion 202 of FIG. 2 that includes the mechanical coupling protrusions 208, 210 and the plurality of communication contacts 212. As illustrated, the mechanical coupling protrusions 208, 210 are configured to extend away from a surface of the connection portion 202, which in this case is perpendicular although other angles are also contemplated.

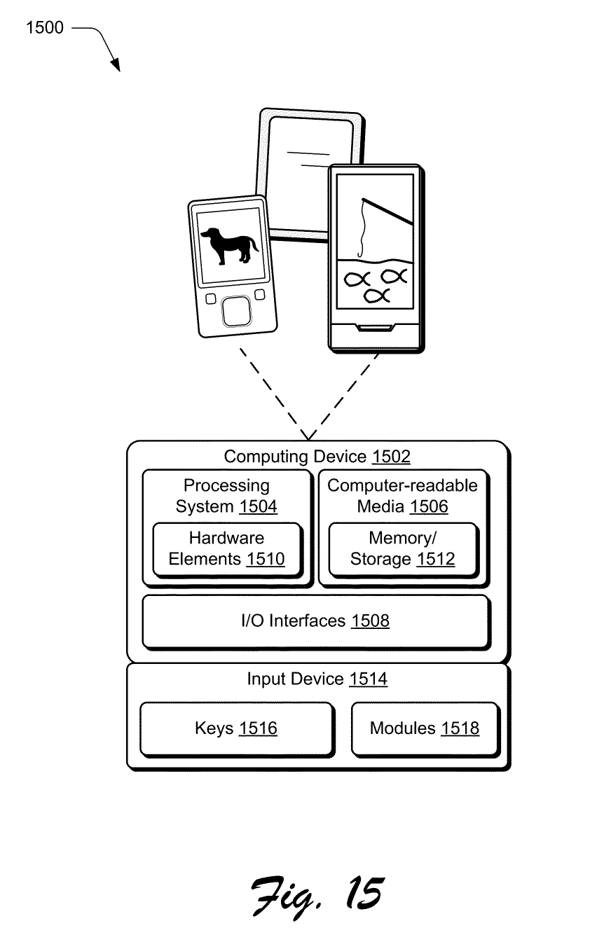

The mechanical coupling protrusions 208, 210 are configured to be received within complimentary cavities within the channel of the computing device 102. When so received, the mechanical coupling protrusions 208, 210 promote a mechanical binding between the devices when forces are applied that are not aligned with an axis that is defined as correspond to the height of the protrusions and the depth of the cavity, further discussion of which may be found in relation to FIG. 14.

The connection portion 202 is also illustrated as including a plurality of communication contacts 212. The plurality of communication contacts 212 is configured to contact corresponding communication contacts of the computing device 102 to form a communicative coupling between the devices as shown and discussed in greater detail in relation to the following figure.

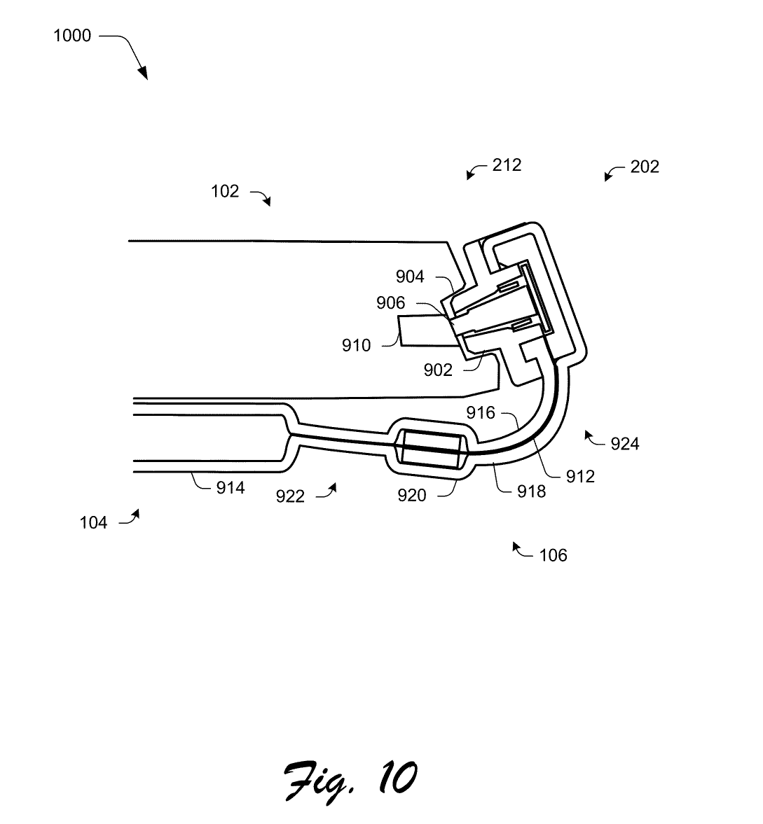

FIG. 9 depicts a cross section taken along an axis 900 of FIGS. 2 and 8 showing one of the communication contacts 212 as well as a cross section of a cavity of the computing device 102 in greater detail. The connection portion 202 is illustrated as including a projection 902 that is configured to be complimentary to a channel 904 of the computing device 102, e.g., having complimentary shapes, such that movement of the projection 902 within the cavity 904 is limited.

The communication contacts 212 may be configured in a variety of ways. In the illustrated example, the communication contact 212 of the connection portion 202 is formed as a spring loaded pin 906 that is captured within a barrel 908 of the connection portion 202. The spring loaded pin 906 is biased outward from the barrel 908 to provide a consistent communication contact between the input device 104 and the computing device 102, such as to a contact 910 of the computing device 102. Therefore, contact and therefore communication may be maintained during movement or jostling of the devices. A variety of other examples are also contemplated, including placement of the pins on the computing device 102 and contacts on the input device 104.

The flexible hinge 106 is also shown in greater detail in the example of FIG. 9. The flexible hinge 106 in this cross section includes a conductor 912 that is configured to communicatively coupled the communication contact 212 of the connection portion 202 with an input portion 914 of the input device 104, e.g., one or more keys, a track pad, and so forth. The conductor 912 may be formed in a variety of ways, such as a copper trace that has an operational flexibility to permit operation as part of the flexible hinge, e.g., to support repeated flexing of the hinge 106. Flexibility of the conductor 912, however, may be limited, e.g., may remain operational to conduct signals for flexing that is performed above a minimum bend radius.

Accordingly, the flexible hinge 106 may be configured to support a minimum bend radius based on the operational flexibility of the conductor 912 such that the flexible hinge 106 resists flexing below that radius. A variety of different techniques may be employed. The flexible hinge 106, for instance, may be configured to include first and second outer layers 916, 918, which may be formed from a fabric, microfiber cloth, and so on. Flexibility of material used to form the first and/or second outer layers 916, 918 may be configured to support flexibility as described above such that the conductor 912 is not broken or otherwise rendered inoperable during movement of the input portion 914 in relation to the connection portion 202.

In another instance, the flexible hinge 106 may include a mid-spine 920 located between the connection portion 202 and the input portion 914. The mid-spine 920, for example, includes a first flexible portion 922 that flexible connects the input portion 904 to the mid-spine 920 and a second flexible portion 924 that flexible connects the mid-spine 920 to the connection portion 920.

In the illustrated example, the first and second outer layers 916, 918 extend from the input portion 914 (and act as a cover thereof) through the first and second flexible portions 922, 924 of the flexible hinge 106 and are secured to the connection portion 202, e.g., via clamping, adhesive, and so on. The conductor 912 is disposed between the first and second outer layers 916, 918. The mid-spine 920 may be configured to provide mechanical stiffness to a particular location of the flexible hinge 106 to support a desired minimum bend radius, further discussion of which may be found in relation to the following figure.

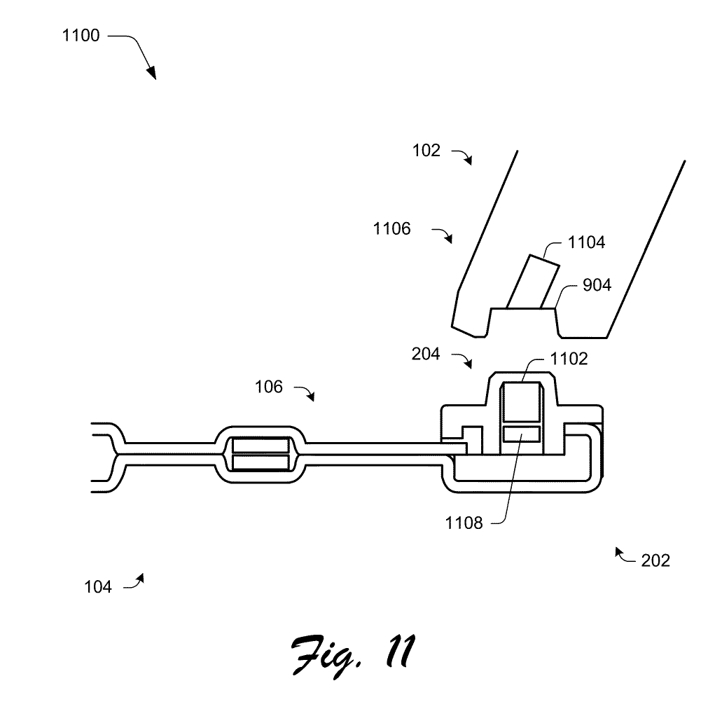

FIG. 10 depicts a cross section of the computing device 102, connection portion 202 and flexible hinge 106 of the input device 104 as being oriented as shown in FIG. 3 in which the input device 104 acts as a cover for a display device 110 of the computing device 102. As illustrated, this orientation causes the flexible hinge 106 to bend. Through inclusion of the mid-spine 920 and sizing of the first and second flexible portions 922, 924, however, the bend does not exceed an operational bend radius of the conductor 912 as previously described. In this way, the mechanical stiffness provided by the mid-spine 920 (which is greater than a mechanical stiffness of other portions of the flexible hinge 106) may protect the conductors 912.

The mid-spine 920 may also be used to support a variety of other functionality. For example, the mid-spine 920 may support movement along a longitudinal axis as shown in FIG. 1 yet help restrict movement along a latitudinal axis that otherwise may be encountered due to the flexibility of the flexible hinge 106.

Other techniques may also be leveraged to provide desired flexibility at particular points along the flexible hinge 106. For example, embossing may be used in which an embossed area, e.g., an area that mimics a size and orientation of the mid-spine 920, is configured to increase flexibility of a material, such as one or more of the first and second outer layers 916, 918, at locations that are embossed. An example of an embossed line 214 that increases flexibility of a material along a particular axis is shown in FIG. 2. It should be readily apparent, however, that a wide variety of shapes, depths, and orientations of an embossed area are also contemplated to provide desired flexibility of the flexible hinge 106.

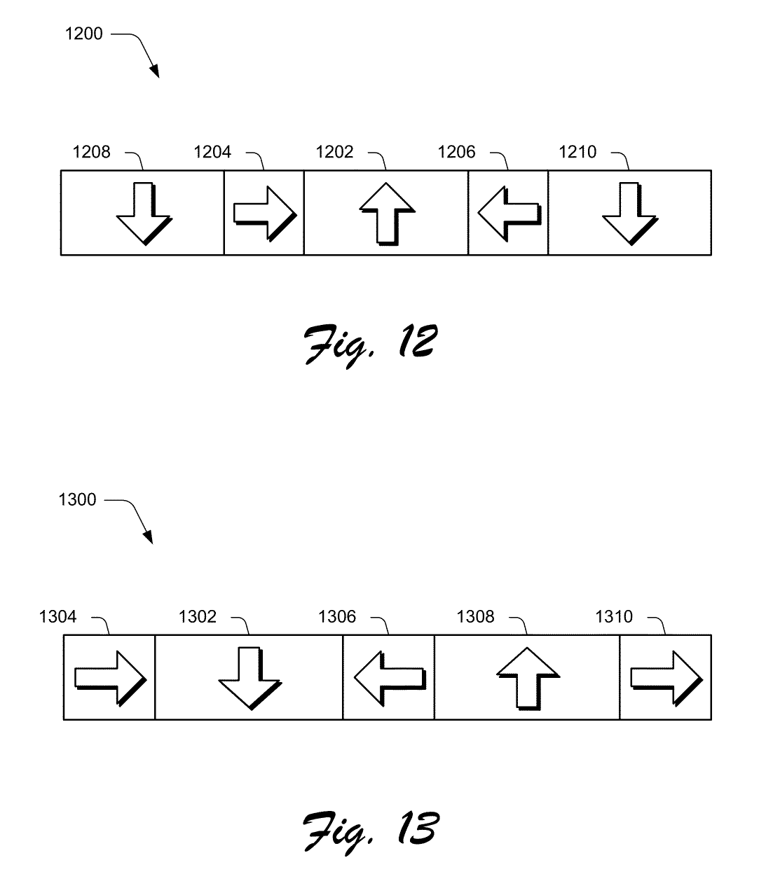

FIG. 11 depicts a cross section taken along an axis 1100 of FIGS. 2 and 8 showing the magnetic coupling device 204 as well as a cross section of the cavity 904 of the computing device 102 in greater detail. In this example, a magnet of the magnetic coupling device 204 is illustrated as disposed within the connection portion 202.

Movement of the connection portion 202 and the channel 904 together may cause the magnet 1102 to be attracted to a magnet 1104 of a magnetic coupling device 1106 of the computing device 102, which in this example is disposed within the channel 904 of a housing of the computing device 102. In one or more implementations, flexibility of the flexible hinge 106 may cause the connection portion 202 to “snap into” the channel 904. Further, this may also cause the connection portion 202 to “line up” with the channel 904, such that the mechanical coupling protrusion 208 is aligned for insertion into the cavity 1002 and the communication contacts 208 are aligned with respective contacts 910 in the channel.

The magnetic coupling devices 204, 1106 may be configured in a variety of ways. For example, the magnetic coupling device 204 may employ a backing 1108 (e.g., such as steel) to cause a magnetic field generated by the magnet 1102 to extend outward away from the backing 1108. Thus, a range of the magnetic field generated by the magnet 1102 may be extended. A variety of other configurations may also be employed by the magnetic coupling device 204, 1106, examples of which are described and shown in relation to the following referenced figure.

FIG. 12 depicts an example 1200 of a magnetic coupling portion that may be employed by the input device 104 or computing device 102 to implement a flux fountain. In this example, alignment of a magnet field is indicted for each of a plurality of magnets using arrows.

A first magnet 1202 is disposed in the magnetic coupling device having a magnetic field aligned along an axis. Second and third magnets 1204, 1206 are disposed on opposing sides of the first magnet 1202. The alignment of the respective magnetic fields of the second and third magnets 1204, 1206 is substantially perpendicular to the axis of the first magnet 1202 and generally opposed each other.

In this case, the magnetic fields of the second and third magnets are aimed towards the first magnet 1202. This causes the magnetic field of the first magnet 1202 to extend further along the indicated axis, thereby increasing a range of the magnetic field of the first magnet 1202.

The effect may be further extended using fourth and fifth magnets 1208, 1210. In this example, the fourth and fifth magnets 1208, 1210 have magnetic fields that are aligned as substantially opposite to the magnetic field of the first magnet 1202. Further, the second magnet 1204 is disposed between the fourth magnet 1208 and the first magnet 1202. The third magnet 1206 is disposed between the first magnet 1202 and the fifth magnet 1210. Thus, the magnetic fields of the fourth and fifth magnets 1208, 1210 may also be caused to extend further along their respective axes which may further increase the strength of these magnets as well as other magnets in the collection. This arrangement of five magnets is suitable to form a flux fountain. Although five magnets were described, any odd number of magnets of five and greater may repeat this relationship to form flux fountains of even greater strength.

To magnetically attach to another magnetic coupling device, a similar arrangement of magnets may be disposed “on top” or “below” of the illustrated arrangement, e.g., so the magnetic fields of the first, fourth and fifth magnets 1202, 1208, 1210 are aligned with corresponding magnets above or below those magnets. Further, in the illustrated example, the strength of the first, fourth, and fifth magnets 1202, 1208, 1210 is stronger than the second and third magnets 1204, 1206, although other implementations are also contemplated. Another example of a flux fountain is described in relation to the following discussion of the figure.

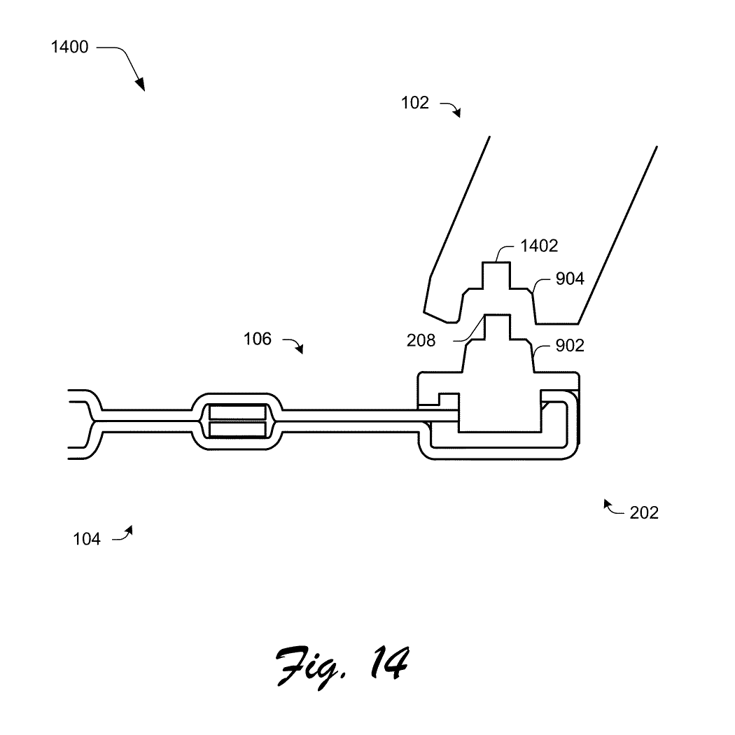

FIG. 13 depicts an example 1300 of a magnetic coupling portion that may be employed by the input device 104 or computing device 102 to implement a flux fountain. In this example, alignment of a magnet field is also indicted for each of a plurality of magnets using arrows.

Like the example 1200 of FIG. 12, a first magnet 1302 is disposed in the magnetic coupling device having a magnetic field aligned along an axis. Second and third magnets 1304, 1306 are disposed on opposing sides of the first magnet 1302. The alignment of the magnetic fields of the second and third magnets 1304, 1306 are substantially perpendicular the axis of the first magnet 1302 and generally opposed each other like the example 1200 of FIG. 12.

In this case, the magnetic fields of the second and third magnets are aimed towards the first magnet 1302. This causes the magnetic field of the first magnet 1302 to extend further along the indicated axis, thereby increasing a range of the magnetic field of the first magnet 1302.

This effect may be further extended using fourth and fifth magnets 1308, 1310. In this example, the fourth magnet 1308 has a magnetic field that is aligned as substantially opposite to the magnetic field of the first magnet 1302. The fifth magnet 1310 has a magnetic field that is aligned as substantially corresponding to the magnet field of the second magnet 1304 and is substantially opposite to the magnetic field of the third magnet 1306. The fourth magnet 1308 is disposed between the third and fifth magnets 1306, 1310 in the magnetic coupling device.

This arrangement of five magnets is suitable to form a flux fountain. Although five magnets are described, any odd number of magnets of five and greater may repeat this relationship to form flux fountains of even greater strength. Thus, the magnetic fields of the first 1302 and fourth magnet 1308 may also be caused to extend further along its axis which may further increase the strength of this magnet.

To magnetically attach to another magnetic coupling device, a similar arrangement of magnets may be disposed “on top” or “below” of the illustrated arrangement, e.g., so the magnetic fields of the first and fourth magnets 1302, 1308 are aligned with corresponding magnets above or below those magnets. Further, in the illustrated example, the strength of the first and fourth magnets 1302, 1308 (individually) is stronger than a strength of the second, third and fifth magnets 1304, 1306, 1310, although other implementations are also contemplated.

Further, the example 1200 of FIG. 12, using similar sizes of magnets, may have increased magnetic coupling as opposed to the example 1300 of FIG. 13. For instance, the example 1200 of FIG. 12 uses three magnets (e.g. the first, fourth, and fifth magnets 1202, 1208, 1210) to primarily provide the magnetic coupling, with two magnets used to “steer” the magnetic fields of those magnets, e.g., the second and third magnets 1204, 1206. However, the example 1300 of FIG. 13 uses two magnets (e.g., the first and fourth magnets 1302, 1308) to primarily provide the magnetic coupling, with three magnets used to “steer” the magnetic fields of those magnets, e.g., the second, third, and fifth magnets 1304, 1306, 1308.

Accordingly, though, the example 1300 of FIG. 13, using similar sizes of magnets, may have increased magnetic alignment capabilities as opposed to the example 1200 of FIG. 12. For instance, the example 1300 of FIG. 13 uses three magnets (e.g. the second, third, and fifth magnets 1304, 1306, 1310) to “steer” the magnetic fields of the first and fourth magnets 1302, 1308, which are used to provide primary magnetic coupling. Therefore, the alignment of the fields of the magnets in the example 1300 of FIG. 13 may be closer than the alignment of the example 1200 of FIG. 12.

Regardless of the technique employed, it should be readily apparent that the “steering” or “aiming” of the magnetic fields described may be used to increase an effective range of the magnets, e.g., in comparison with the use of the magnets having similar strengths by themselves in a conventional aligned state. In one or more implementations, this causes an increase from a few millimeters using an amount of magnetic material to a few centimeters using the same amount of magnetic material.

An LCD layer may also be disposed underneath the keys such that the keys may be selectively lit, e.g., responsive to an application. One application would be a teaching app that lights up the keys as desired to train people, e.g. memory tests, media training, and so on.

Example System and Device

FIG. 15 illustrates an example system generally at 1500 that includes an example computing device 1502 that is representative of one or more computing systems and/or devices that may implement the various techniques described herein. The computing device 1502 may be, for example, be configured to assume a hand held configuration through use of a housing formed and size to be grasped and carried by one or more hands of a user, illustrated examples of which include a mobile phone, mobile game and media device, and tablet computer although other examples are also contemplated.

The example computing device 1502 as illustrated includes a processing system 1504, one or more computer-readable media 1506, and one or more I/O interface 1508 that are communicatively coupled, one to another. Although not shown, the computing device 1502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1504 is representative of functionality to perform one or more operations using hardware. Accordingly, the processing system 1504 is illustrated as including hardware element 1510 that may be configured as processors, functional blocks, and so forth. This may include implementation in hardware as an application specific integrated circuit or other logic device formed using one or more semiconductors. The hardware elements 1510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1506 is illustrated as including memory/storage 1512. The memory/storage 1512 represents memory/storage capacity associated with one or more computer-readable media. The memory/storage component 1512 may include volatile media (such as random access memory (RAM)) and/or nonvolatile media (such as read only memory (ROM), Flash memory, optical disks, magnetic disks, and so forth). The memory/storage component 1512 may include fixed media (e.g., RAM, ROM, a fixed hard drive, and so on) as well as removable media (e.g., Flash memory, a removable hard drive, an optical disc, and so forth). The computer-readable media 1506 may be configured in a variety of other ways as further described below.

Input/output interface(s) 1508 are representative of functionality to allow a user to enter commands and information to computing device 1502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1502 may be configured in a variety of ways to support user interaction.

The computing device 1502 is further illustrated as being communicatively and physically coupled to an input device 1514 that is physically and communicatively removable from the computing device 1502. In this way, a variety of different input devices may be coupled to the computing device 1502 having a wide variety of configurations to support a wide variety of functionality. In this example, the input device 1514 includes one or more keys 1516, which may be configured as pressure sensitive keys, mechanically switched keys, and so forth.

The input device 1514 is further illustrated as include one or more modules 1518 that may be configured to support a variety of functionality. The one or more modules 1518, for instance, may be configured to process analog and/or digital signals received from the keys 1516 to determine whether a keystroke was intended, determine whether an input is indicative of resting pressure, support authentication of the input device 1514 for operation with the computing device 1502, and so on.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1502. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1510 and computer-readable media 1506 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1510. The computing device 1502 may be configured to implement particular instructions and/or functions corresponding to the software and/or hardware modules. Accordingly, implementation of a module that is executable by the computing device 1502 as software may be achieved at least partially in hardware, e.g., through use of computer-readable storage media and/or hardware elements 1510 of the processing system 1504. The instructions and/or functions may be executable/operable by one or more articles of manufacture (for example, one or more computing devices 1502 and/or processing systems 1504) to implement techniques, modules, and examples described herein.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. An input device comprising:
a connection portion comprising:
at least one communication contact configured to form a communicative coupling with a computing device; and
a magnetic coupling device to form a removable magnetic attachment to the computing device to secure the connection portion to the computing device;
an input portion comprising a plurality of keys that are configured to generate signals to be processed by a computing device as inputs, the signals to specify processing of media to be performed by the computing device; and
a flexible hinge that is configured to flexibly connect the connection portion to the input portion, the flexible hinge having one or more conductors configured to communicatively couple the plurality of keys with the communication contact.

2. An input device as described in claim 1, wherein at least one said input specifies processing of the media by the computing device that includes beat synchronization.

3. An input device as described in claim 1, wherein at least one said input specifies processing of the media by the computing device that includes production or editing of the media.

4. An input device as described in claim 1, wherein at least one said input specifies processing of the media by the computing device that includes mixing of the media.

5. An input device as described in claim 1, wherein at least one said input specifies processing of the media by the computing device that includes a video editing operation.

6. An input device as described in claim 1, wherein at least a portion of the plurality of keys are configured to provide an output that is indicative of an amount of pressure applied to a respective said key.

7. An input device as described in claim 6, wherein the amount or pressure is used to control a velocity of sound output as part of an output of the media.

8. An input device as described in claim 1, wherein the flexible hinge is flexible in an amount that is sufficient to orient the input device in:
a first orientation with respect to the computing device to cover at least a portion of a display device of the computing device; and
a second orientation with respect to the computing device to cover at least a rear portion of a housing of the computing device that is opposite of a side of the housing that includes the display device.

9. An input device as described in claim 1, wherein the connection portion is configured as a projection that is configured to be received within a channel of a housing the computing device, the projection including the at least one communication contact and the magnetic coupling device.

10. An input device as described in claim 9, wherein:
the at least one communication contact is located at an approximate midpoint of the projection along a longitudinal axis of the projection; and
at least a portion of the conductor is located at a corresponding approximate midpoint of the flexible hinge.

11. An input device as described in claim 1, wherein the flexible hinge is configured to permit rotational movement of the input device in relation to the computing device that mimics a cover of a book along a first axis and restricts movement of the input device in relation to the computing device along a second axis that is substantially perpendicular to the first axis.

12. An input device as described in claim 1, wherein at least a portion of the plurality of keys forms a sound pad.

13. An input device comprising:
an input portion configured to generate signals to be processed by a computing device as inputs for processing of media, the input portion including a radial dial pad;
a connection portion comprising:
at least one communication contact configured to form a communicative coupling with the computing device to communicate the generated signals; and
a magnetic coupling device to form a removable magnetic attachment to the computing device; and
a flexible hinge that is configured to flexibly connect the connection portion to the input portion.

14. An input device as described in claim 13, wherein the radial dial pad is configured to provide an output indicative of an amount of pressure applied to at least a portion of the radial dial pad.

15. An input device as described in claim 13, wherein the radial dial pad is configured to provide an output to cause an application of the computing device to navigate between items of said media.

16. A system comprising:
a computing device having a housing that assumes a handheld form factor; and
an input device comprising a connection portion configured to be removably physically secured to the computing device using magnetism which, when so secured, supports a communicative coupling between a plurality of keys of the input device and the computing device, one or more said keys configured to provide inputs to an application that is executable on the computing device to process music using beat synchronization.

17. A system as described in claim 16, wherein at least a portion of the one or more said keys is configured to act as a sound pad.

18. A system as described in claim 16, wherein the connection portion is secured to an input portion of the input device that includes the plurality of keys using a flexible hinge.

19. A system as described in claim 18, wherein the flexible hinge is flexible in an amount that is sufficient to orient the input device in:
a first orientation with respect to the computing device to cover at least a portion of a display device of the computing device; and
a second orientation with respect to the computing device to cover at least a rear portion of a housing of the computing device that is opposite of a side of the housing that includes the display device.

20. An input device as described in claim 18, wherein the flexible hinge is configured to permit rotational movement of the input device in relation to the computing device that mimics a cover of a book along a first axis and restricts movement of the input device in relation to the computing device along a second axis that is substantially perpendicular to the first axis.
